(19) United States
(12) Patent Application Publication
(10) Pub. No.: US 2014/0112463 A1
(43) Pub. Date: Apr. 24, 2014

(54) METHOD AND SYSTEM TO ESTABLISH A CALL TO A CONTACT CENTER

(71) Applicant: IDEAL SYSTEMS NV, Vilvoorde (BE)

(72) Inventors: Bart Koen Victor Ghesquière, Sint-Denijs-Westrem (BE); Peter Gilbert Jeanine Depoorter, Veurne (BE); Koen Jan Johanna Verhaegen, Opdorp (BE); Dirk Joseph Louisa Slootmaekers, Kontich (BE)

(73) Assignee: IDEAL SYSTEMS NV, Vilvoorde (BE)

(21) Appl. No.: 13/655,872

(22) Filed: Oct. 19, 2012

(51) Int. Cl. H04M 1/56

(52) U.S. Cl. 379/142.04

(57) ABSTRACT

A method to establish a call to a contact center from a smart device includes: scanning a code with a camera or sensor of the smart device; decoding the code to obtain a reference to a call application; running the call application; decoding the code to obtain a telephone number or reference to a telephone number of the contact center and content data; initiating a telephone call to the contact center; transferring the content data and a caller identification over a data network to a remote data storage system; the contact center contacting the remote data storage system to verify presence of content data associated with the caller identification of the telephone call; and the contact center obtaining the content data and using the content data for further handling the telephone call.

### FIELD OF THE INVENTION

The present invention generally relates to establishing calls to an inbound contact center, i.e. a contact center that receives large volumes of requests by telephone. Such an inbound contact center is typically setup to organize product support for customers or to administer information inquiries in general like for instance inquiries with respect to appointments, quotes, received documents such as invoices, bank notes, official receipts, governmental letters, etc. The present invention in particular aims at automating the process of collecting and transferring the data that are typically shared when a call to contact center is established.

### BACKGROUND OF THE INVENTION

A contact center typically hosts a number of contact center agents. Each contact center agent is equipped with a workstation that comprises a desktop or laptop computer and a telephone set or headset that is connected to a telephone switch. A contact center can operate independently or it can be networked with other contact centers. Often, the voice and data paths in a contact center are linked through so called CTI or Computer Telephony Integration technology.

In order to route an incoming call, i.e. to direct a call to a contact center agent that is qualified and available to service the incoming call, contact centers usually deploy a touch-tone interface or speech-enabled interface, i.e. an introductory menu that requires the caller to make a selection or provide certain information through touch-based interaction with buttons or the touch screen of his/her device, or through speech.

Such contact center menus typically are time consuming for the caller to listen to. Further, answering the contact center menu requires several manual interventions of the caller that are error-sensitive. The caller either must press buttons in a certain order or spell phrases. In case a wrong button is touched, or the voice instructions of the caller are misinterpreted, the call is unavoidably misrouted and the caller must re-call the contact center or is confronted with a call transfer. A further drawback of the known way of establishing a call with a contact center is that all information that will be requested as a result of the call menu must be collected in advance by the caller: a customer ID, an invoice number, a license plate number, a document reference, etc. must be available to the caller when requested by the contact center menu. As an alternative, contact center menus can be kept short, leaving the contact center agent where the call is routed to with the burden to collect all necessary information from the caller during the first minutes of the conversation. This obviously has a negative impact on the efficiency of contact centers.

It has been suggested already to use QR codes to initiate a telephone call to a predetermined number of a contact center. The article “QR Codes in directory services” for instance mentions that promotional material can be provided with a QR code that enables to take users directly to the contact center of the company issuing the promotional material. This article can be retrieved from the Internet via the following URL: http://www.voltdelta.net/en/resources/directories-newsletter/directories-issue1/

The caller however is left with problems similar to the ones experienced when he/she has to enter the telephone number of the contact center manually: lengthy contact center menus, touch-based or speech-enabled interaction with a contact center menu that is error prone which may lead to inadequate routing of the call to a contact center agent that cannot service the call, and necessity to manually collect information that will be requested in interaction with the contact center menu or contact center agent.

It is an objective of the present invention to disclose a method and system for establishing a call with a contact center that overcomes the above mentioned drawbacks of existing methods. More particularly, it is an objective of the present invention to disclose a method and system for establishing a call with a contact center that reduces the burden on the caller for collecting information and sharing information through touch-tone or voice-enabled interaction with a contact center menu. It is a further objective of the present invention to reduce the average time needed to establish a call with a contact center and to render the establishment of such call less error prone thereby improving the overall efficiency of contact centers in terms of call duration and successful routing of calls to call agents.

### SUMMARY OF THE INVENTION

According to the present invention, the above identified objectives are realized by the method to establish a call to a contact center from a smart device as defined by claim 1, the smart device having a camera or sensor, connectivity to a telephone network, connectivity to a data network, and a processing unit for running applications, the method comprising the steps of:
scanning a code with the camera or sensor of the smart device;
decoding the code to thereby obtain a reference to a call application;
the processing unit automatically running the call application;
decoding the code to thereby obtain a telephone number or reference to a telephone number of the contact center and content data;
the call application initiating a telephone call via the telephone network to the telephone number of the contact center;
the call application transferring the content data and a caller identification of the telephone call via the data network to a remote data storage system;
the contact center upon receipt of the telephone call contacting the remote data storage system to verify presence of content data associated with the caller identification of the telephone call; and
the contact center obtaining the content data from the remote data storage system and using the content data for further handling the telephone call.

Thus, the invention relies on the scanning of a code that contains three types of information. Firstly, the code contains a reference to a call application, i.e. a dedicated software program or app that must be activated on the caller's smart device. The reference may for instance be an URL to the webpage where the call application can be downloaded for installation. Secondly, the code contains a telephone number of the contact center, or equivalently a reference to a telephone number of the contact center. The reference may for instance be a link to a web service returning the telephone number of the contact center. Such reference enables to change the telephone number without having to change the code. The call application shall use this telephone number to automatically call the contact center from the smart device. In other words, a voice channel is established between the smart device and the contact center without requiring the caller to enter the telephone number. Thirdly, the code contains content data, e.g. a language indication, document identification like for instance an invoice number, a customer identification, a license plate number, a car chassis number, etc. that is decoded by the call application and sent over a parallel data connection to a remote data storage system, e.g. a cloud storage platform or database that can be reached over the Internet. Parallel to establishing a voice channel, the call application running on the smart device hence establishes a data channel to a remote storage system and the call application automatically transfers to the remote storage system the information that is traditionally shared during the first minutes of a call to a contact center. Upon receipt of a call, application software at the contact center side shall contact the remote storage system to verify if data were transferred to the data storage system. The contact center application software thereto shall use the caller ID extracted from the incoming voice call. In case data were transferred, the contact center application software shall collect the data, interpret and use the data for further handling of the call, e.g. routing the call to an appropriate contact center agent that can service the call. The caller no longer needs to manually collect the information that is requested by the contact center menu or the contact center agent, the caller no longer has to listen to and interpret a contact center menu, and the caller no longer has to respond to the contact center menu. This substantially shortens establishment of a call to a contact center, and reduces the chances for errors and/or the caller lacking certain information as a result of which calls would have to be interrupted and repeated or transferred. As a result of the invention, the call can be routed to an appropriate contact center agent based on information extracted from the code and/or the latter contact center agent can be provided with useful information enabling a more personalized handling of the voice call.

The code can be a printed code, like a QR-code or barcode, that has sufficient capacity to contain the three types of information or a reference to that information and that can be scanned using a camera integrated in the smart device. Alternatively, the code can form part of a visible or invisible tag, e.g. an RFID (Radio Frequency Identification) tag or NFC (Near Field Communications) tag, that can be scanned using a sensor, e.g. an RFID reader or NFC reader, integrated in the smart device.

According to an optional aspect defined by claim 2, the method to establish a call to a contact center according to the present invention further comprises:
downloading the call application and installing the call application on the smart device before running the call application.

Indeed, in case the call application is not yet installed on the smart device at the point in time the code is scanned, the call application may be downloaded and installed on the smart device. Thereafter, the call application is run for decoding the telephone number of the contact center and the additional content data from the code.

In a preferred embodiment of the method to establish a call to a contact center according to the present invention, defined by claim 3, the code is a QR code wherein the reference to the call application, the telephone number of the contact center, and the content data are encoded.

Indeed, one possible implementation of a code wherein a substantive amount of information comprising a reference to a call application, a telephone number and additional content data can be encoded, is a QR or Quick Response code. Such QR code has the advantage over traditional barcodes that the amount of information that can be encoded is larger, but the use of barcodes or alternative, codes that can be scanned using a camera or sensor, is not excluded to implement variants of the method according to the present invention. The method according to the invention makes inventive use of the QR code or alternative code in that two layers of information are encoded. The code is scanned to obtain a reference to the call application and to trigger download/installation/running the call application. Thereafter the call application is used to decode the telephone number of the contact center and the additional content data from the code. The call application shall use this information for parallel setup of a voice channel towards the contact center and a data channel towards the remote storage platform.

As further defined by claim 4, further handling the telephone call may comprise:
routing the telephone call to a contact center agent;
routing the telephone call automatically through a contact center menu; or
routing the telephone call to a self service option that answers a specific question of the caller.

Thus, the content data that are sent over the parallel data channel to the data storage system and that are obtained by the contact center from this data storage system, may be interpreted by a contact center application and used to route the voice call to the appropriate contact center agent that can service the call. Alternatively, the content data may be used by a contact center application to route the voice call automatically through a contact center menu without requiring the caller to manually make choices in such menu. The contact center agent where the call is routed to finally may have the content data appear on his screen such that a more efficient and more personalized handling of the call becomes possible. It is further noticed that the content data may also be interpreted to route the call to a self service option where the specific question of the caller is answered.

As defined by claim 5, the content data in the method to establish a call to a contact center according to the present invention, may comprise one or more of:
a language identification;
a person identification;
a document identification;
a product identification; and
a reference to a language identification, a person identification, a document identification, a product identification and/or other information useful for improving the quality or efficiency of the call handling, stored in a database accessible from the smart device via a network.

Indeed, examples of content data that may be encoded in the code for use during establishment of a call to a contact center are a language identification enabling to route the call to a contact center agent that speaks the language of the caller; a person identification enabling to route the call to a contact center agent that is for instance responsible for that person's account; a document identification such as an invoice number enabling to route the call to a contact center agent knowledgeable on invoicing and enabling to provide the contact center agent automatically with the relevant invoice on his screen during the call; a product identification such as a serial number enabling to route the call to a contact center agent that can provide support or assistance on the identified product and enabling to automatically inform the contact center agent on product related information such as most frequent questions and answers, the warranty status of the product, the maintenance history of the product, etc. Instead, the content data may contain a reference to a language-, person-, document- and/or product identification stored in a database or cloud storage facility that is for instance accessible for the smart device via the Internet. Obviously, the present invention is not restricted to any particular type of content data that is encoded in the code used for establishment of the call to a contact center. Depending on the application, all kinds of information that are useful in the call to a contact center and typically shared between the caller and the contact center menu or contact center agent during the first minutes of a call, can be integrated in the code. In case of a call to a car service center, the information encoded in the code may for instance comprise a license plate number, the name of the car holder, the name of the car fleet company, the car's chassis number, the car type and model, etc.

In addition to the method defined by claim 1, the present invention also relates to a corresponding system to establish a call to a contact center from a smart device as defined by claim 6, the smart device comprising a camera or sensor, connectivity to a telephone network, connectivity to a data network, and a processing unit for running applications, the system comprising:
a code comprising an encoded reference to a call application, an encoded telephone number of the contact center, and encoded content data;
a call application comprising software code able to decode the code to thereby obtain the telephone number or reference to a telephone number of the contact center and content data, software code able to initiate a telephone call via the telephone network to the telephone number of the contact center, software code able to transfer the content data and a caller identification of the telephone call via the data network to a remote data storage system;
a remote data storage system configured to receive and store the content data and the caller identification; and
a contact center application comprising software code able to contacting the remote data storage system upon receipt of the telephone call to verify presence of content data associated with the caller identification of the telephone call, software code able to obtain the content data from the remote data storage system, and software code able to use the content data for further handling the telephone call.

The present invention further relates to a call application as defined by claim 7 comprising software code enabling to perform the method of the invention, and to a computer readable storage medium comprising the call application as defined by claim 8.

The present invention also relates to a contact center application as defined by claim 9 comprising software code enabling to perform the method of the invention, and to a computer readable storage medium comprising the contact center application as defined by claim 10.

In addition, the present invention relates to a remote data storage system as defined by claim 11, for use in the system according to the invention.

The present invention also concerns a corresponding code for use in the system according to the invention, the code being configured to comprise an encoded reference to a call application, an encoded telephone number or reference to a telephone number of a contact center, and encoded content data. Such code is defined by claim 12.

### BRIEF DESCRIPTION OF THE DRAWINGS

FIG. 1 is a diagram illustrating the steps of an embodiment of the method for establishing a call to a contact center according to the present invention executed at the smart device;

FIG. 2 is a diagram illustrating the steps of an embodiment of the method for establishing a call to a contact center according to the present invention executed at the contact center;

FIG. 3 illustrates a QR code as used in an embodiment of the present invention; and

FIG. 4 illustrates an embodiment of the system for establishing a call to a contact center according to the present invention.

### DETAILED DESCRIPTION OF EMBODIMENT(S)

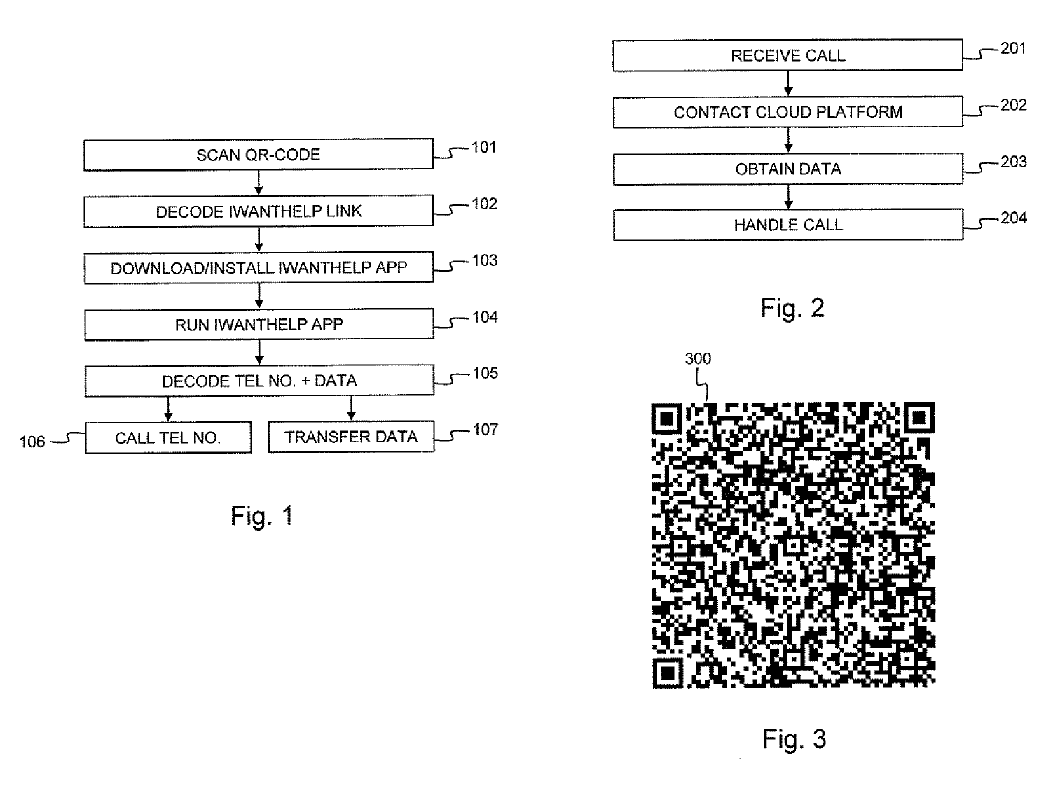

FIG. 1 illustrates the different steps executed in an embodiment of the present invention on a smart device, e.g. a smartphone, tablet PC, laptop, kiosk or other portable device that is equipped with a camera, network connectivity to a data network such as the Internet, and voice connectivity to a telephone network such as a GSM network.

In a first step labelled 101 in FIG. 1, a QR-code printed on a document or product is scanned with the camera of the smart device. This QR-code is shown in FIG. 3 where it is labelled 300.

The QR-code 300 is decoded with a standard QR-reader available on the smart device in step 102 as a result of which a link to a website where the IWantHelp application can be downloaded, is obtained. The IWantHelp application is a call application that must be installed on the smart device in order to assist in making calls to contact centers in a manner according to the present invention.

In a third step labelled 103 in FIG. 1, the IWantHelp application is downloaded from the website referenced by the QR-code 300, and the IWantHelp application is installed on the smart device. It is noticed that steps 101, 102 and 103 are only executed the first time a QR-code that refers to the IWantHelp application is scanned on a particular smart device. These steps will no longer be executed when further QR-codes that refer to the IWantHelp application are scanned at a point in time this application is already installed on the smart device.

In a fourth step labelled 104 in FIG. 1, the IWantHelp application is opened. A processor in the smart device shall run the IWantHelp application.

The IWantHelp application shall decode a telephone number from the QR-code 300 and additional data in the next step labelled 105 in FIG. 1. The QR-code in other words is decoded using the IWantHelp application as a result of which a second layer of information is uncovered. In a specific embodiment where a car fleet card with QR-code 300 is scanned in order to get assistance from a Carglass contact center for repairing a broken windshield, the QR-code 300 shall for instance contain:

Module: Carglass Fleet Belux

Dial In Number: 011 30 17 17

Language: N

Fleet: Arval Operational Lease

Car Owner: Jan Peeters

Make/Model: BMW 320d

Licence Plate: 1-DNP-562

Chassis Number: WVWZZZ17ZDW541648

Call Origin: Car Convenience Card

The above decoded Dial In Number is then used in step 106 by the IWantHelp application to automatically initiate a voice call from the smart device to the lease company's contact center. Thereto, a voice connection is established over a telephone network, e.g. a GSM network.

In parallel, the IWantHelp application shall transfer in step 107 the additional information decoded from the QR-code 300 to a remote storage platform, e.g. a cloud based platform operated and managed by a third party. The IWantHelp application thereto uses a parallel data channel and registers the additional information in the remote storage system together with a caller identification that is used in step 106 to initiate a call to the lease company's contact center.

FIG. 2 illustrates the steps that are subsequently executed by an application running at the lease company's contact center to receive inbound calls.

In step 201, the contact center application receives the voice call from the smart device initiated automatically after scanning the QR-code 300 and decoding it with the IWantHelp application.

The received call contains a caller identification that is used by the contact center application in step 202 to contact the cloud storage system where the IWantHelp application registers additional data decoded from QR-codes. The contact center application contacts the cloud storage system to verify if information coming from the caller of the just received call has been transferred and stored.

Thereupon, in step 203, the contact center application shall obtain the additional data stored in the cloud storage platform for the caller ID.

The received data shall be used in step 204 to efficiently handle the incoming call within the contact center. In the above example for instance, the received information shall be used to automatically select the language “Nederlands” in the contact center menu, to route the call to an appropriate Carglass contact center that can service the call, and to forward the information “Fleet”, “Car Owner”, “Make/Model”, “License Plate”, “Chassis Number” and “Call Origin” automatically over the Internet to the Carglass contact center that will handle the call in order to avoid that the agent answering the telephone call must collect this information from the caller by interrogating the caller for several minutes.

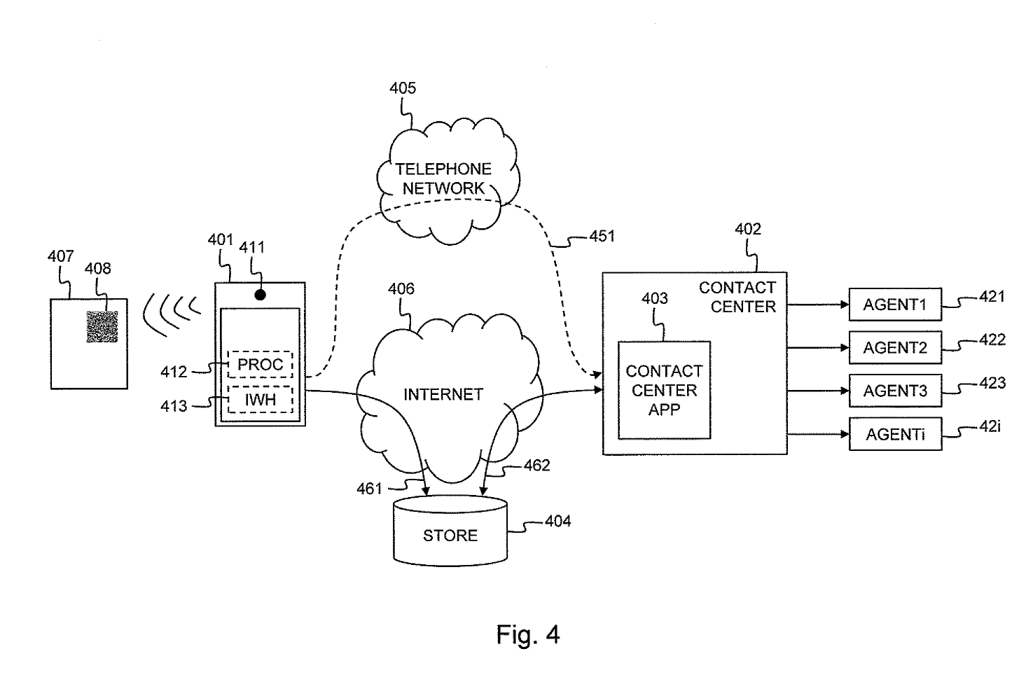

FIG. 4 shows the different components in a system operating according to the present invention. Smartphone 401 contains a camera 411 and a processor 412 whereon the IWantHelp application, 413 or IWH, can run. The camera 411 scans the QR-code 408 printed on document 407 as a result of which the IWantHelp application 413 will be downloaded, installed and opened on the smartphone 401. Thereafter, the QR-code is decoded by the IWantHelp application 413 which decodes a telephone number of contact center 402 as well as additional data from the QR-code 408. The IWantHelp application 413 initiates a telephone call 451 to the contact center 402 using the telephone number decoded from the QR-code 408. The IWantHelp application 413 thereto uses the telephone network interface of smartphone 401 to telephone network 405, e.g. the GSM interface. In parallel, the IWantHelp application transfers the additional data decoded from QR-code 408 over a data channel 461 to a remote storage platform 404. The data are there stored together with a caller identification used to setup the telephone call 451. The data may for instance be transferred over the Internet 406 or an alternative data network connection that is available in the smartphone 401. The remote data store 404 can for instance be a cloud storage platform hosted and managed by a third party. A contact center application 403 running on a server at the contact center 402 to receive and handle inbound calls receives the telephone call 451 and thereupon consults the remote data store 404 in order to verify if additional data were stored by the caller. The additional data shall thereupon be transferred to the contact center application as is indicated by 462 in FIG. 4. The contact center application 403 shall then use the received data to further handle the incoming call, e.g. to route the call automatically to an appropriate contact center agent 421, 422, 423 . . . 42i, and to provide the receiving contact center agent with useful information to efficiently service the call 451.

It is noticed that the remote data store 404 wherein the additional data are stored may not be remote to the contact center in alternative embodiments. This data store 404 may be a server or database located in the contact center as a result of which no connection 462 over the Internet is needed.

It is further noticed that in alternative embodiments, the data channel 461 used to transfer the additional data to the remote data store 404, may be bi-directional in order to better inform the caller before the telephone conversation with the contact center agent is started.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1. A method to establish a call to a contact center from a smart device including a camera or sensor, connectivity to a telephone network, connectivity to a data network, and a processing unit configured to run applications, comprising:
scanning a code with said camera or sensor of said smart device;
decoding said code to thereby obtain a reference to a call application;
automatically running said call via said processing unit application;
decoding said code to thereby obtain a telephone number or reference to a telephone number of said contact center and content data;
initiating via said call application a telephone call via said telephone network to said telephone number of said contact center;
transferring via said call application said content data and a caller identification of said telephone call via said data network to a remote data storage system;
upon receipt of said telephone call at said contact center, contacting via said contact center said remote data storage system to verify presence of content data associated with said caller identification of said telephone call; and
obtaining said content data from said remote data storage system via said contact center and using said content data to further handle said telephone call.

2. The method to establish a call to a contact center according to claim 1, comprising:
downloading said call application and installing said call application on said smart device before running said call application.

3. The method to establish a call to a contact center according to claim 1,
wherein said code is a QR code wherein said reference to said call application, said telephone number of said contact center, and said content data are encoded.

4. The method to establish a call to a contact center according to claim 1,
wherein further handling said telephone call comprises:
routing said telephone call to a contact center agent;
routing said telephone call automatically through a contact center menu; or
routing said telephone call to a self service option that answers a specific question of a caller.

5. The method to establish a call to a contact center according to claim 1,
wherein said content data comprise one or more of:
a language identification;
a person identification;
a document identification;
a product identification; and
a reference to at least one of a language identification, a person identification, a document identification, a product identification and other information useful for improving quality or efficiency of said handling of said telephone call.

6. A system to establish a call to a contact center from a smart device including a camera or sensor, connectivity to a telephone network, connectivity to a data network, and a processing unit configured to run applications, said system comprising:
a code comprising an encoded reference to a call application, an encoded telephone number or reference to a telephone number of said contact center, and encoded content data;
a call application comprising software code able to decode said code to thereby obtain said telephone number of said contact center and content data, software code able to initiate a telephone call via said telephone network to said telephone number of said contact center, software code able to transfer said content data and a caller identification of said telephone call via said data network to a remote data storage system;
said remote data storage system configured to receive and store said content data and said caller identification; and
a contact center application comprising software code able to contact said remote data storage system upon receipt of said telephone call to verify presence of content data associated with said caller identification of said telephone call, software code able to obtain said content data from said remote data storage system, and software code able to use said content data for further handling said telephone call.

7. A call application comprising software code enabling the performance of the method of claim 1.

8. A computer readable storage medium comprising the call application of claim 6.

9. A contact center application comprising software code enabling the performance of the method of claim 1.

10. A computer readable storage medium comprising the contact center application of claim 9.

11. A code for use in the system of claim 6, configured to comprise an encoded reference to a call application, an encoded telephone number or reference to a telephone number of a contact center, and encoded content data.
